(19) United States
(12) Patent Application Publication
(10) Pub. No.: US 2006/0012539 A1
(43) Pub. Date: Jan. 19, 2006

(54) Display device

(76) Inventors: Tsutomu Matsuhira, (US); Hiroaki Hanawa, (US); Koichi Tanigawa, (US); Tadao Konno, (US)

Correspondence Address: BRUCE L. ADAMS, ESQ.;SUITE 1231, 17 BATTERY PLACE, NEW YORK, NY, 10004, US

(21) Appl. No.: 11/178,746

(22) Filed: Jul. 11, 2005

(30) Foreign Application Priority Data
Jul. 13, 2004 (JP) 2004-205384
Feb. 25, 2005 (JP) 2005-051310

(51) Int. Cl. G09G 5/00

(52) U.S. Cl. 345/1.1

(57) ABSTRACT

With a double-sided display module having a main panel and a sub-panel sharing drive signals, the image quality of the main panel is improved. When the display devices uses the same driver IC to drive the main panel and the sub-panel, the contrast is uneven at the border area between a region of the main panel where signal electrodes share drive signals with the sub-panel and a region of the main panel where signals electrodes do not share drive signals. In order to make the contrast unevenness practically invisible to the naked eye, an unshared electrode adjacent to the border between different contrast levels on the main panel is connected to the dummy electrode. The dummy electrode has to be smaller than the total overlap area of one electrode that constitutes a pixel of the sub-panel. In the case where the sub-panel has more than one dummy electrode, the dummy electrodes are gradually made smaller.

### BACKGROUND OF THE INVENTION

1. Field of the Invention

The present invention relates to a double-sided display module having on each side a display panel such as a passive matrix liquid crystal panel, an active matrix liquid crystal panel or an organic EL panel, and to cellular phones, PDAs (Personal Digital Assistants) and other electronic appliances that use this type of display device.

2. Description of the Related Art

In conventional display devices, for example, display device having STN liquid crystal display panels, linear segment electrodes and common electrodes (which are formed of ITO) are arranged in a matrix shape to build a dot matrix as shown in FIG. 15. A liquid crystal layer is provided between these electrodes. And, an oriented film such as a polyimide film is formed on a surface of each electrode. When voltages are applied by time division to the two types of electrode, in other words, when segment signals and common signals are respectively supplied to the two linear electrode groups, image, text and the like are displayed on a screen of the display panel. The signals are applied by connecting an output electrode of a driver IC to each linear electrode. At present, while a driver IC that outputs segment signals and common signals is built on one chip if the pixel count is 160×128 dots or so, display panels having a higher pixel count use a driver IC dedicated to segment signals and a driver IC dedicated to common signals separately. Some display devices even use more than two driver ICs in accordance with the relation between the drive signal output count of a drive IC and the pixel count.

Many of recent cellular phones are of the shell type, which open into two halves, and an increasing number of such products take a form that has a main screen and a sub-screen mounted back to back as display screens (hereinafter referred to as double-sided display module). JP 2000-338483 A discloses a display device in which two back-to-back screens are built from separate display panels and two display-panel-driving ICs are provided to drive the display panels separately. In another proposal, two display panels are driven by one driver IC that is capable of handling the total pixel count of the two screens. This method, when applied to, for example, an STN liquid crystal display module, has signals supplied to the sub-display panel from a side that is opposite the side where drive signals are inputted to the main display panel. According to this method, segment signals are shared between the two panels by supplying some of segment signals to the sub-display panel via segment electrodes, which are display electrodes, of the main display panel. Common signals are supplied to the sub-display panel through the periphery of the main display panel from a sub-screen common signal connection terminal, which is provided on each outer side of a main panel common signal connection terminal, which in turn is provided on each outer side of a segment signal connection terminal at an electric connection portion between the main panel and the driver IC. The method thus enables one driver IC to drive the two display panels. In still another method proposed, a stream of signals outputted from an IC is branched at a connection terminal that supplies the main panel with the signals and the branched stream is supplied to the sub-panel, so that common signals as well as segment signals, are shared between the two panels.

However, driving the main panel and the sub-panel of the double-sided panel module by one chip lowers the image quality of the main panel of the double-sided panel in a manner that causes a contrast difference between a region of the main panel that shares drive signals with the sub-panel and a region that does not. FIG. 14 shows an example of a circuit diagram in which a driver IC is connected to a main panel and sub-panel of an STN liquid crystal display device. In gray scale display, the contrast is uneven at the border between a region of the main panel that shares drive signals with the sub-panel and a region that does not. The unevenness in contrast results from a large liquid crystal capacity difference between the region where drive signals are shared and the rest of the main panel. In the circuit diagram of FIG. 14, the contrast is uneven in two portions of the main panel, one between COM4 and COM5, and the other between COM68 and COM69.

### SUMMARY OF THE INVENTION

An object of the present invention is therefore to provide a display device that eliminates a contrast difference between a region of a main panel that shares drive signals with a sub-panel and a region that does not.

In a display device of the present invention, an unshared electrode adjacent to the border between different contrast levels on a main panel is connected to a dummy electrode formed in a sub-panel. The dummy electrode has to be smaller than the total overlap area of one electrode that constitutes a pixel of the sub-panel. In the case where the sub-panel has more than one dummy electrode, the dummy electrodes are made smaller gradually. This reduces the liquid crystal capacity gradually and thus makes contrast differences small enough to be unrecognizable by the human eye. In other words, in a display device that uses the same driver IC to drive a main panel and sub-panel of a double-sided panel module, a signal electrode group of the main panel that shares drive signals with the sub-panel is connected to a dummy electrode group constituted of dummy electrodes which are formed on the sub-panel in a manner that decreases the capacity load gradually, so that the contrast unevenness at the border between signal electrodes that share drive signals and signal electrodes that do not is practically invisible.

However, the single use of this method does not prevent a noticeable unevenness from stretching like a belt on the main panel between a region that is connected to the sub-panel and a region that is not when the capacity in the sub-panel is large, in particular, when the main panel displays in gray monochrome.

The present invention solves this by wiring the driver IC to the main panel such that wires that are connected to the sub-panel are larger in wiring resistance than wires that are not. The cause of the contrast unevenness is obscuring of a drive waveform due to a delay. A theoretical circuit expression simplifying the delay schematically can be expressed using the dielectric dissipation factor tan δ. When a main panel capacity is given as C1, a sub-panel capacity as C2, the wiring resistance of main panel wires that are used to drive the main panel alone as R1, and the wiring resistance of main panel wires that are connected to and drive the sub-panel as R2, an angular frequency ω, a dielectric dissipation factor tan δ1 for driving the main panel alone, and a dielectric dissipation factor tan δ2 for driving the main panel while connected to the sub-panel have the following relation:
tan δ1=tan δ2 Expression (1)
ω×C1×R1=ω×(C1+C2)×R2 Expression (2)
R1=(C1+C2)/C1×R2 Expression (3)

The wiring resistance of the main panel can be designed theoretically by setting, as calculated from the expression, the wiring resistance R1 larger than the wiring resistance R2 of the main panel wires that are connected to the sub-panel. The wiring resistance of the main panel may vary from region to region. In otherwords, gradual variations may be found also in wiring resistance of the main panel wires that are used to drive the main panel alone, which makes the contrast uneven, though not to the point of visibility. In such cases, an adjustment of the wiring resistance is needed only at the border between a region where wires are used to drive the main panel alone and a region where wires are connected to and drive the sub-panel. Theoretically, designing the wiring resistance as this solves the contrast unevenness.

In practice, however, the ON resistance of the driver IC fluctuates, and the main panel and the sub-panel may differ from each other in terms of liquid crystal material, capacity, and others. Furthermore, there are process-induced variations including wiring resistance variations depending on the thickness of the ITO film, etching conditions, and the baking temperature; capacity variations depending on the area of wiring of the main and sub-panels as well as the gap between the main and sub-panels; a change in capacity from when the liquid crystals of the display screens are on and to when they are off; and various parasitic capacitances. Since there are also differences between different material lots and between different production lots, it is very difficult to completely solve the problem of uneven contrast by correcting the wiring resistance alone.

Therefore, in addition to correcting the wiring resistance in the manner described above, the present invention sets an intermediate value between the above tan δ1 and tan δ2 to the border between a region of the main panel where wires are used to drive the main panel alone and a region where wires are connected to and drive the subpanel. This is achieved by placing, in the sub-panel, dummy electrodes having a capacity half the total capacity of the sub-panel and connecting the dummy electrodes to electrodes disposed at a region bordering with the region where wires are used to drive the main panel alone. The wiring resistance of the border electrodes is set to an intermediate value between the wiring resistance of the wires that are used to drive the main panel alone and the wires that are connected to and drive the sub-panel, so that the border electrodes can have an approximately intermediate tan δ value between tan δ1 and tan δ2 despite wiring resistance fluctuation or sub-panel capacity fluctuation caused by some factor. In short, the contrast unevenness is made invisible to the naked eye by making the contrast shift gradually. To even out the contrast unevenness further and obtain more uniform image quality, the number of dummy electrodes is increased until the dummy electrodes have progressively smaller areas at, if possible, a uniform reduction rate while, in reverse proportion to the dummy area, the wiring resistance is raised gradually at, again, if possible, a uniform rate.

### BRIEF DESCRIPTION OF THE DRAWINGS

In the accompanying drawings:

FIG. 1 is a schematic diagram outlining a display device of the present invention;

FIG. 2 is a schematic diagram showing the exterior of a display device according to the present invention;

FIG 3 is a schematic diagram of a display device of the present invention viewed from its sub-panel side;

FIG. 4 is an exterior view of a terminal portion of a main panel;

FIG. 5 is an exterior view of a first FPC with a driver IC mounted thereto;

FIG. 6 is an exterior view of a second FPC;

FIG. 7 is an exterior view of a terminal portion of a sub-panel;

FIG. 8 is a schematic diagram showing a display device with a main panel and a first FPC mounted thereto;

FIG. 9 is a schematic diagram showing a display device with a sub-panel and a second FPC mounted thereto;

FIG. 10 is a circuit diagram schematically showing how a driver IC, a main panel and a sub-panel are connected according to the present invention;

FIG. 11 is a schematic diagram showing the structure of electrodes in a sub-panel according to the present invention;

FIG. 12 is a circuit diagram schematically showing how a driver IC, a main panel and a sub-panel are connected according to the present invention;

FIG. 13 is a schematic diagram showing the structure of electrodes in a sub-panel according to the present invention;

FIG. 14 is a circuit diagram showing an example of connecting a driver IC, a main panel and a sub-panel;

FIG. 15 is a schematic diagram illustrating transparent electrodes of a conventional display panel;

FIG. 16 is a schematic diagram showing the structure of electrodes in a main panel according to the present invention;

FIG. 17 is a schematic diagram showing the structure of electrodes in a main panel according to the present invention;

FIG. 18 is a schematic diagram showing the structure of electrodes in a sub-panel according to the present invention; and

FIG. 19 is a circuit diagram schematically showing how a driver IC, a main panel and a sub-panel are connected according to the present invention.

### DETAILED DESCRIPTION OF THE PREFERRED EMBODIMENTS

A display device according to the present invention has a first display panel, a second display panel, and a driver IC. Drive signals outputted from the driver IC are shared between and supplied to both the first and second display panels. The second display panel is smaller in pixel count than the first display panel. The first display panel has a region that shares drive signals with the second display panel and a region that does not. In order to make gradual changes in capacity load on the driver IC at the border between the signal sharing region and the non-signal sharing region, dummy electrodes are placed in the second display panel. In order to minimize the area of the electrodes, the dummy electrodes formed in the second display panel take up a small area to be smaller in capacity than electrodes that constitute pixels of the second display panel. More dummy electrodes bring better results by making the load capacity of the dummy electrodes change in a continuous manner between electrodes that share signals with the second display panel and electrodes that do not. Wires connecting the first display panel to the driver IC are divided into wires that are used to drive the first display panel alone and wires that are used to drive the first display panel and the second display panel both. The wires that are used to drive the first display panel alone are given a larger wiring resistance than the wires that are used to drive the first display panel and the second display panel both. In the region of the first display panel that is connected to the dummy electrodes, the wiring resistance is made to shift gradually to fill up the difference in wiring resistance between the wires that are used to drive the first display panel alone and the wires that are used to drive the first display panel and the second display panel both.

A display device according to the present invention includes: a first display screen; a second display screen which has a smaller pixel count than the first display screen; and a driver IC which outputs common drive signals to be supplied to the first display screen and the second display screen to drive the first and second display screens both, and which outputs drive signals to be supplied to drive the first display screen alone. Moreover, a dummy electrode is provided in the second display screen aside from linear electrodes, which constitute pixels, and the drive signals are supplied to the dummy electrode.

The dummy electrodes are placed outside of the linear electrodes on the second display panel. When there is more than one dummy electrode, the plural dummy electrodes are arranged adjacent to one another. The plural dummy electrodes are smaller in area than the line electrodes, which constitute pixels, and have progressively smaller areas as the distance from the pixels increase. Wires connecting the first display panel to the driver IC are divided into wires that are used to drive the first display panel alone and wires that are used to drive the first display panel and the second display panel both. The wires that are used to drive the first display panel alone are given a larger wiring resistance than the wires that are used to drive the first display panel and the second display panel both.

In the region of the first display panel that is connected to the dummy electrodes, the wiring resistance is made to shift gradually, in reverse proportion to the increase/decrease in dummy electrode capacity, to fill up the difference in wiring resistance between the wires that are used to drive the first display panel alone and the wires that are used to drive the first display panel and the second display panel both.

### First Embodiment

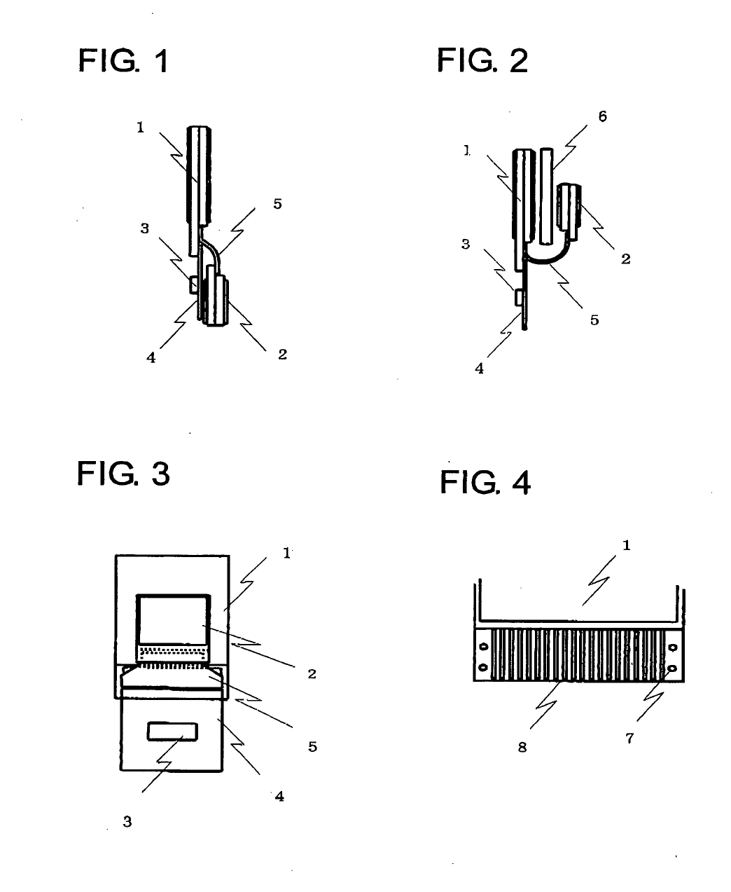

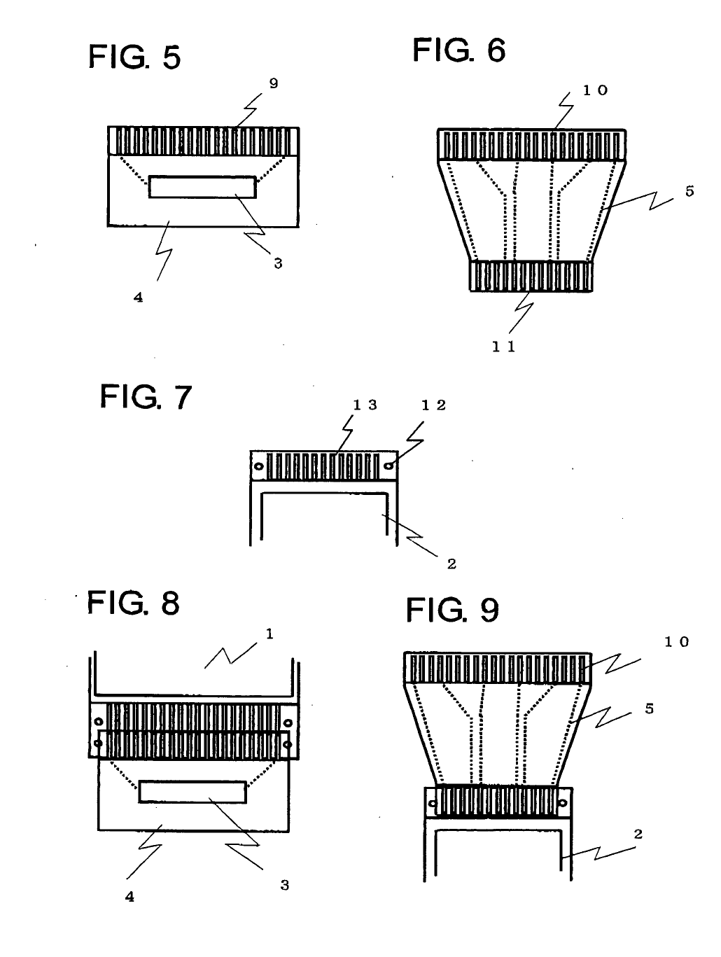

A liquid crystal display device according to this embodiment will be described with reference to the accompanying drawings. FIG. 1 is a side view of the display device before a backlight is installed therein. A first FPC 4 with a driver IC 3 mounted thereto supplies drive signals to a main panel 1, and a second FPC 5 supplies drive signals to a sub-panel 2. FIG. 2 schematically shows the display device with a backlight 6 placed between the main panel 1 and the sub-panel 2. The backlight 6, which emits light to the front and back, supplies light to the main panel 1 and the sub-panel 2 both. A schematic diagram of the display device in this state, which is viewed from the side of the sub-panel 2, is shown in FIG. 3. However, the backlight 6 is not shown in FIG. 3. Now, a detailed description is given on the module structure with reference to schematic diagrams of the components of the display device. FIG. 4 is an enlarged view of a terminal portion of the main panel 1. Two identification marks 7 are provided on the left and right each to facilitate the connecting work. Electrode terminals 8 for supplying drive signals from the driver IC 3 to display (linear) electrodes are arranged at regular intervals between the left hand side identification marks 7 and the right hand side identification marks 7. FIG. 5 is an exterior view of the first FPC 4 with the driver IC 3 mounted thereto. As many connection terminals 9 as the electrode terminals 8 of the main panel 1 are formed on the first FPC 4 at the same intervals that are put between the electrode terminals 8. The FPC 4 is formed by forming a seed layer on a polyimide film through sputtering; patterning, through photo etching, a copper material that is formed through sputtering and electroplating; and, after covering with solder resist, applying tin plating. In the case where the FPC 4 is stretched due to packaging conditions, a correction may be made to shrink the connection terminals 9.

FIG. 6 is an exterior view of the second FPC 5, which has the same structure as the first FPC 4. In this embodiment, the second FPC 5 has a first connection terminal group 10 in which as many connection terminals as the electrode terminals 8 of the main panel 1 are formed at the same intervals that are put between the electrode terminals 8. The second FPC 5 also has a second connection terminal group 11 in which as many connection terminals as terminals of the sub-panel 2 are formed at the same intervals that are put between the terminals of the sub-panel 2. In short, in the first connection terminal group 10, connection electrodes that are not connected to the second connection terminal group 11 are arranged in the same manner as those that are connected to the second connection terminal group 11. This is for stabilizing the yield and the reliability when connecting the electrode terminals of the panel to the FPC with an anisotropic conductive film. FIG. 7 is an exterior view of a terminal portion of the sub-panel 2. Drive electrode terminals 13 are formed at regular intervals between an identification mark 12 on the left hand side and an identification mark 12 on the right hand side. FIG. 8 is a schematic diagram showing the first FPC 4 joined to the main panel 1, and FIG. 9 is a schematic diagram showing the second FPC 5 joined to the sub-panel 2. The connection terminals of the second FPC 5 are connected to the main panel 1 at a position indicated by the inner identification marks formed on the main panel 1. Thus wiring and connecting the driver IC to the two display panels is completed.

A liquid crystal that can be driven on a normal voltage is employed for the main panel 1. On the other hand, the sub-panel 2 employs a liquid crystal that is driven on a low voltage. The main panel 1 is a normally-black screen whereas the sub-panel 2 is a normally-white screen. While the main panel 1 is in use, the liquid crystal of the sub-panel 2 is in an ON state and the sub-panel 2 displays in black irrespective of whether selected or not. While the sub-panel 2 is in use, the sub-panel 2 is driven by partial driving. With such a structure, though no problem arises while the sub-panel 2 is in use, display on the main panel 1 is influenced by the capacity of the sub-panel 2. In gray scale display, in particular, the contrast is low in the region where the electrodes are connected to the sub-panel 2, and a difference in contrast is created between this region and the region where electrodes are not connected to the sub-panel 2, thereby causing a contrast unevenness.

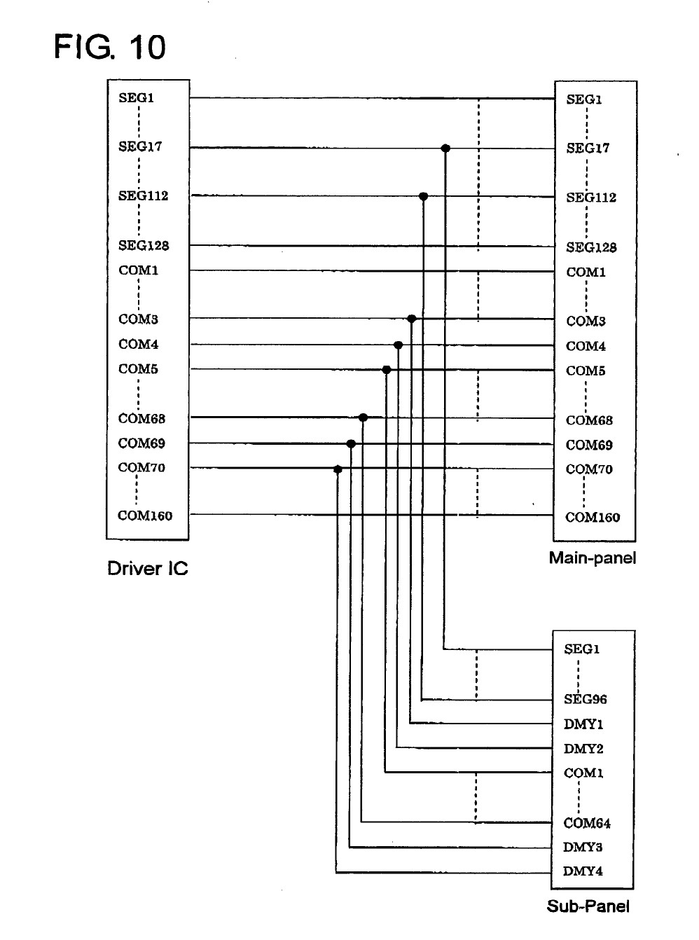

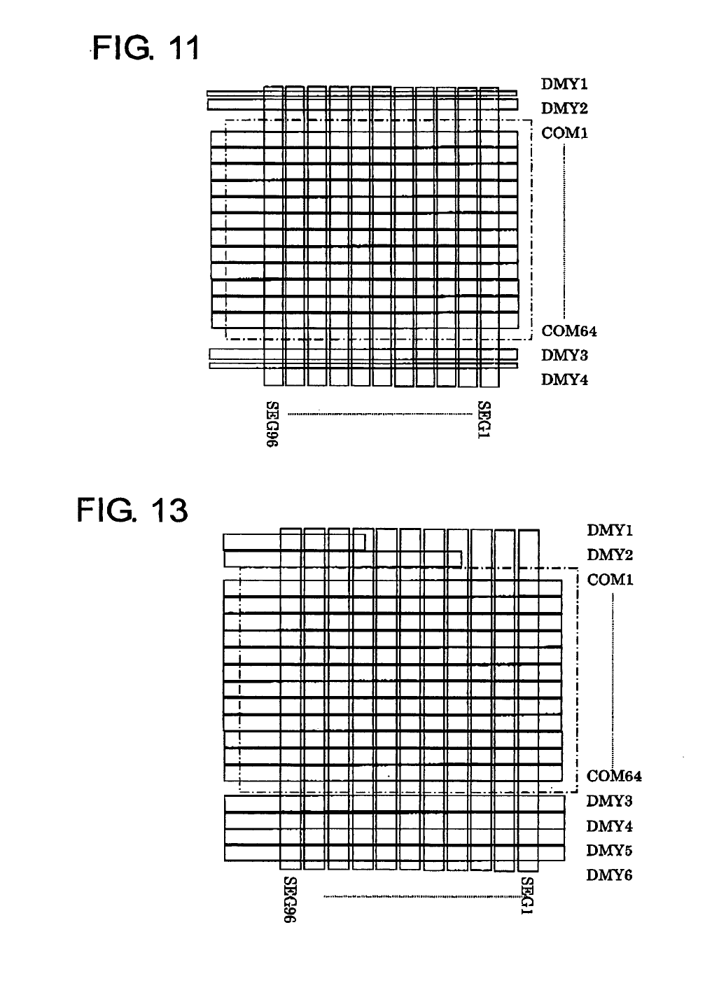

Wiring connection according to this embodiment is described with reference to FIG. 10, which is a schematic circuit diagram, taking as an example the case where the main panel 1 has a pixel count of 128×160 dots and the sub-panel 2 has a pixel count of 96×64 dots (both are STN liquid crystal panels). First, the driver IC and the main panel 1 are connected to each other by wires on a one-on-one basis as is the norm for this type of display device. The sub-panel 2, having a different dot count from the main panel 1, is connected to the driver IC by as many wires as necessary. For instance, electrode terminals SEG1 to SEG96 of the sub-panel 2 are connected to electrode terminals SEG17 to SEG112 of the main panel 1, and electrode terminals COM1 to COM64 of the sub-panel 2 are connected to electrode terminals COM5 to COM68 of the main panel 1. At this point, in addition to connecting the aforementioned electrode terminals, which drive the display screens, COM3 and COM4 and COM69 and COM70 of the main panel 1 are connected to dummy electrodes (DMY1 to DMY4) of the sub-panel 2. The transparent electrodes that constitute the sub-panel 2 are schematically shown in FIG. 11. Portions where the common electrode group (COM1 to COM64) overlaps the segment electrode group (SEG1 to SEG96) like a matrix are used as pixels. The arce indicated by the dot-dashed line is the range of the display screen that is viewable by a user. The dummy electrodes (DMY1 to DMY4) are arranged outside of the area indicated by the dot-dashed line.

With this structure, a contrast difference between the region where the main panel is connected to the sub-panel and the region where the two panels are not connected which results from distortion of the drive signal waveform in the connected region is reduced by using dummy electrodes to make the waveform distortion change gradually. Thus the border between the different contrast levels is obscured and the contrast unevenness is eliminated. In order to shift the contrast gradually, the dummy electrode (DMY2) that is nearer to the display electrodes is given a different width than the dummy electrode (DMY1) nearer to the periphery of the display device. Thus, the capacity of the liquid crystal with linear electrodes changes gradually. Although two dummy electrodes are connected on each COM side in this embodiment, more dummy electrodes produce better results. Although, this embodiment places dummy electrodes only on the COM side, dummy electrodes can similarly be placed on the SEG side in the case where contrast unevenness is found in the SEG side, too.

### Second Embodiment

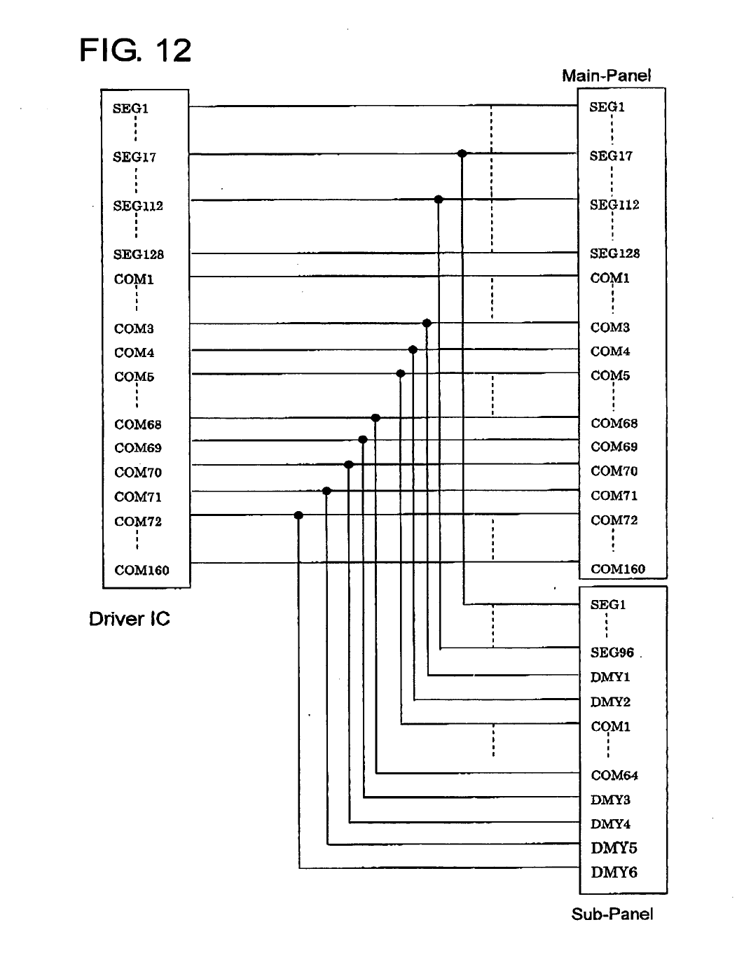

FIG. 13 shows an embodiment in which the dummy electrode shape of the first embodiment is modified. As shown in FIG. 13, the liquid crystal capacity is changed gradually by changing the electrode length. The capacity is gradually decreased from COM1 to DMY2 to DMY1. Since a dummy electrode is reduced in area by changing its width or length, the capacity changes accordingly. The dummy electrodes may be arranged into a comb shape or the shape of the letter L. The dummy electrodes DMY3 to DMY6 at the other border have the same width. Here, four dummy electrodes are placed and connected to the display electrodes COM1 to COM4 of the main panel 1 in the circuit diagram of FIG. 12 with the dummy electrode capacity set equal that of COM5. In this case, because the display electrodes are connected to dummy electrodes having the same load capacity until the ends of the viewable range of the screen, there is no border that divides the screen into different regions. Alternatively, every other display electrode may be connected to a dummy electrode. In this case, the effect of eliminating the contrast unevenness is lessened but a fewer dummy electrodes are needed.

### Third Embodiment

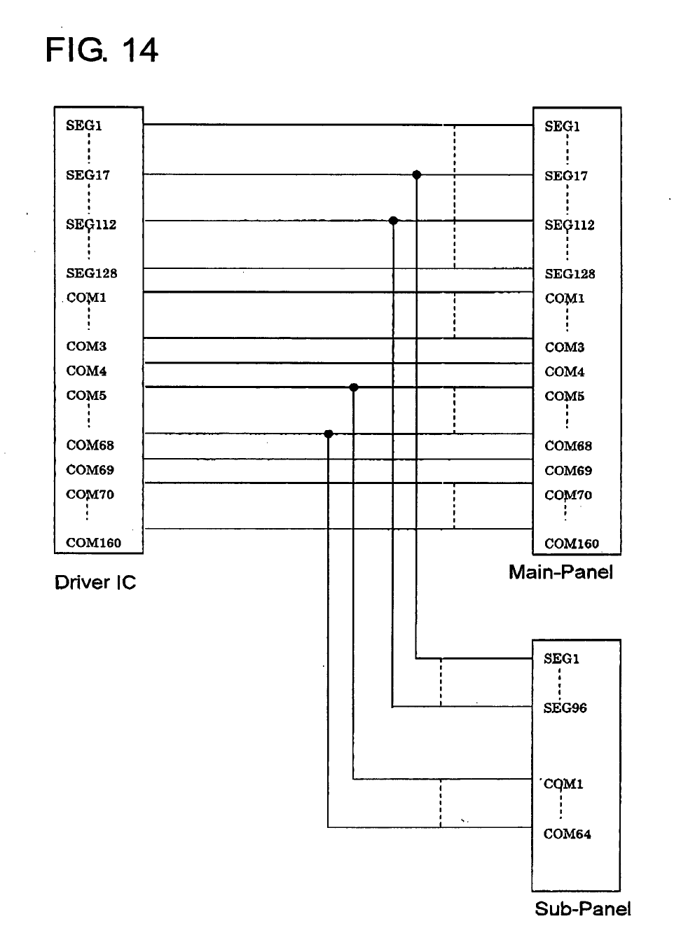

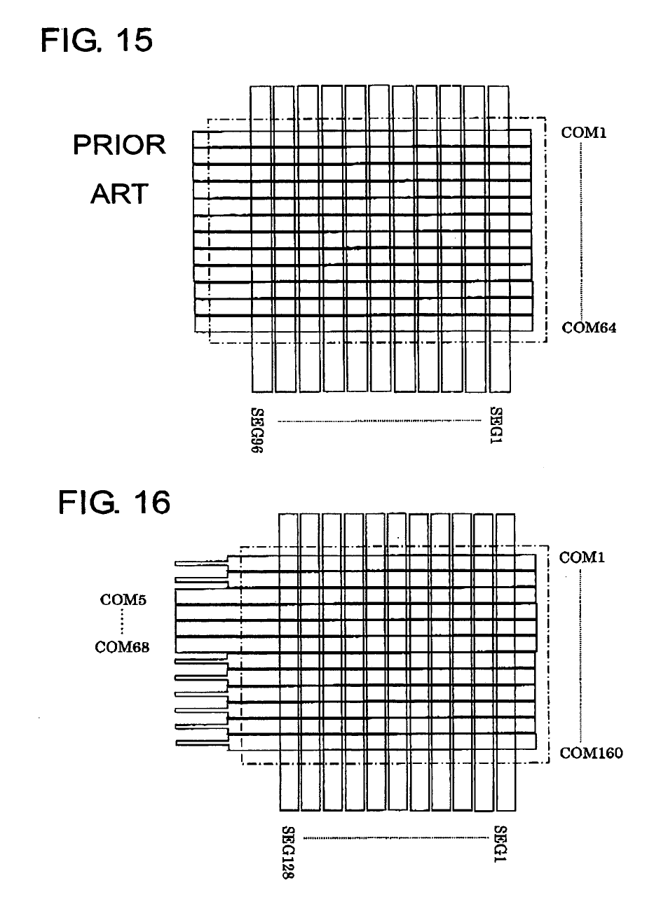

This embodiment remedies the contrast unevenness by utilizing the wiring resistance of ITO wires that connect a driver IC to a main panel and a sub-panel. FIG. 16 schematically shows transparent electrodes that constitute a main panel according to the third embodiment. The circuit structure according to this embodiment is shown in FIG. 14. Transparent electrodes of a sub-panel of this embodiment are structured as shown in FIG. 15. In the main panel shown in FIG. 16, segment signals are applied by a driver IC (not shown in the drawing) from SEG1 to SEG 128 and from the lower side of FIG. 16. Common signals are applied by the driver IC (not shown in the drawing) from the left side of the drawing. Here, the transparent electrodes COM5 to COM68 of the main panel share signals with the sub-panel, and are connected in parallel to the sub-panel as shown in the circuit diagram of FIG. 4. The transparent electrodes COM5 to COM68 of the main panel that are connected to the sub-panel differ in wire width and, accordingly, in wiring resistance, from the rest of the transparent electrodes.

The main panel employs a quick response type liquid crystal, and the liquid crystal capacity of a COM electrode in the main panel is 3.8×10⁻¹⁰ F/μm². The sub-panel employs a low voltage type liquid crystal, and the liquid crystal capacity of a COM electrode in the sub-panel is 1.97×10⁻¹⁰ F/μm². While the main panel is displaying images, text and the like, liquid crystal molecules in the sub-panel are all in an ON state irrespective of whether a received drive signal is an ON signal or an OFF signal. In the main panel, the COM electrode COM69 which is not connected to the sub-panel is calculated from the dielectric dissipation factor tan δ and is expressed as tan δ1=ω×C1×R1=3.8×10⁻¹⁰ω·R1, whereas the COM electrode COM68 which is connected to the sub-panel is expressed as tan δ2=ω×R2=(1.97×10⁻¹⁰+3.8×10⁻¹⁰)ω·R2=5.77×10⁻¹⁰ω·R2. Since tan δ1=tan δ2, R1=1.52×R2, and the wiring resistance of COM69 is 1.52 times larger than that of COM68. The wiring resistance is adjusted by decreasing the width of the wires to the pixels.

The sub-panel is of a positive optical design and, while the main panel is displaying images, text and the like, is driven at 1/160 duty in accordance with the liquid crystal drive voltage of the main panel. During this period, every liquid crystal molecule in the sub-panel is in an ON state and therefore the display on the sub-panel completely black. The main panel displays an image having substantially uniform image quality after correcting the wiring resistance. To display images, text and the like on the sub-panel, the sub-panel is driven on a lowered drive voltage at 1/64 duty. The sub-panel can have a uniform image quality since all of its wires are connected to the main panel at the same capacity level. The duty,which is a display drive condition, of the sub-panel is optimized in accordance with the pixel count. A more accurate correction can be made when the driver ON resistance and connection resistance, in addition to the wiring resistance, are taken into consideration. While a correction is made on the COM side in the above embodiment, when there is contrast unevenness on the SEG side, the wiring resistance on the SEG side can similarly be corrected.

### Fourth Embodiment

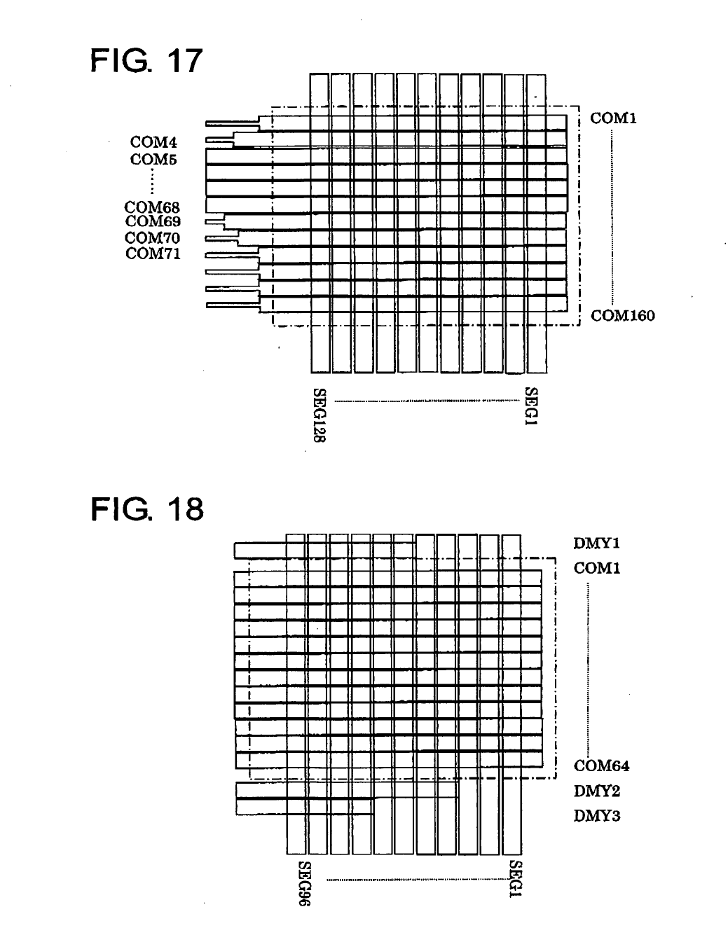

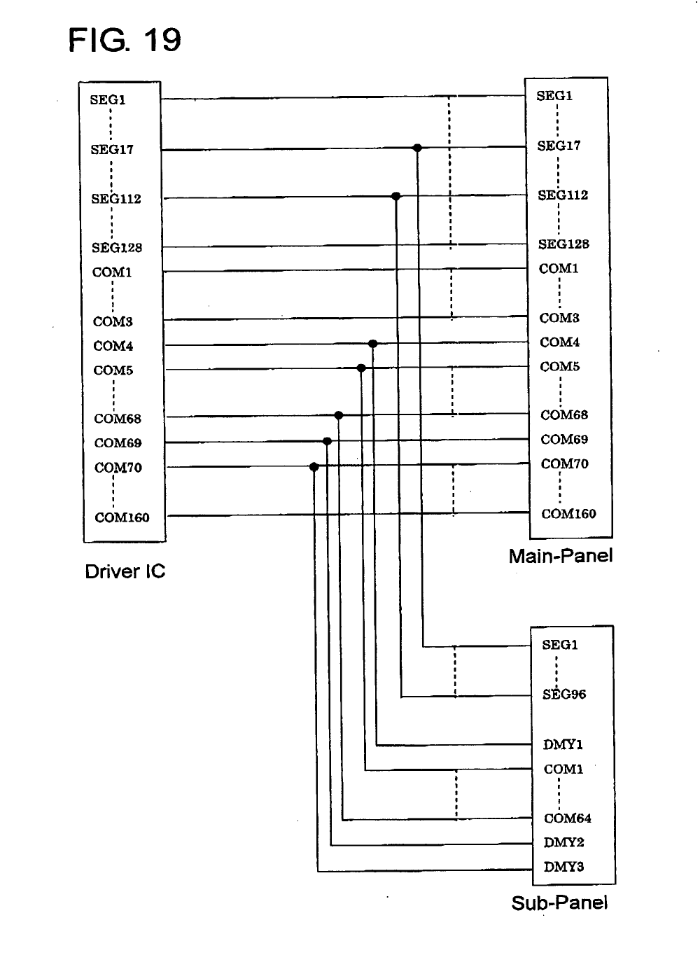

According to this embodiment, in the other region of a main panel than a region (COM5 to COM68) that is connected to a sub-panel, a correction is made to the wiring resistance in a region bordering the region of the main panel that is connected to the sub-panel, and to dummy electrodes formed in the sub-panel in addition to correcting the wiring resistance. FIG. 17 is a frontal view schematically showing transparent electrodes of a main panel. FIG. 18 is a frontal view schematically showing transparent electrodes of a sub-panel. FIG. 19 is a circuit diagram showing the main panel and the sub-panel connected to each other.

The wiring resistance of COM4 of the main panel is designed to be an intermediate value between the wiring resistance of COM5 and the wiring resistance of COM3, and to be 1.26 times larger than the wiring resistance of COM5. DMY1 of the sub-panel connected to COM4 has a capacity half the capacity of COM1 of the sub-panel. COM4 takes an intermediate value between tan δ of COM5 and COM3 despite capacity variations of the main panel and the sub-panel due to different liquid crystal materials employed by the main panel and the sub-panel, or a wiring resistance fluctuation due to an uneven thickness of a wiring film. COM69 and COM70 of the main panel are corrected in two stages. A resistance correction is made to COM69 at a ratio of 33% with respect to COM71, and the resistance of COM 70 is corrected at a ratio of 66%. Conversely, the capacity of a dummy electrode DMY2 of the sub-panel is set to 66% of the capacity of a COM electrode within the display area of the screen, whereas the capacitance of a dummy electrode DMY3 connected to COM70 is set to 33% of the capacity of a COM electrode within the display area of the screen. This way, despite an uneven thickness of a lead-out wiring film, non-uniform etching, and capacity fluctuations due to a liquid crystal gap in the sub-panel, the wiring resistance can be corrected such that the contrast is shifted gradually at the border between a region of the main panel that is connected to the sub-panel and a region of the main panel that is not connected to the sub-panel.

Correcting the wiring resistance and the capacity both in this way evens out the contrast unevenness on the screen and provides a stable image quality particularly for display of images captured by a camera. While corrections are made on the COM side in the above embodiment, when there is a contrast unevenness on the SEG side, wiring resistance on the SEG side can similarly be corrected.

In a double-sided display device, which can be viewed from the front and the back, the present invention solves the problem of uneven display on a main panel of the display device when the main screen is driven with a one-chip structure. The present invention thus provides a display device at a lower cost and with an enhanced image quality.

What is claimed is:

1. A display device comprising:
a first display panel;
a second display panel having a lower pixel count than the first display panel; and
a driver IC which outputs common drive signals to be supplied to the first display panel and the second display panel to drive the first and second display panels both, and which outputs drive signals to be supplied to drive the first display panel alone,
wherein dummy electrode is provided in the second display panel aside from linear electrodes constituting pixels, and
wherein the drive signals are supplied to the dummy electrode.

2. A display device according to claim 1 wherein, the dummy electrode placed outside of a display area of the second display panel.

3. A display device according to claim 1, wherein a plurality of dummy electrodes are arranged adjacent to one another.

4. A display device according to claim 3, wherein the plurality of dummy electrodes are smaller in area than linear electrodes which constitute a display screen, and have progressively smaller areas as a distance from the display scren increases.

5. A display device comprising;
a first display panel;
a second display panel which is smaller in pixel count than the first display panel; and
a driver IC which outputs common drive signals to be supplied to the first display panel and the second display panel to drive the first and second display panels both, and which outputs drive signals to be supplied to drive the first display panel alone,
wherein the first display panel has, in a region other than a region that constitutes pixels, wires that are used to drive the first display panel and the second display panel both, and wires that are used to drive the first display panel alone, and
the resistance of the wires that are used to drive the first display panel alone is larger than the resistance of the wires that are used to drive the first display panel and the display panel both.

6. A display device comprising:
a first display panel;
a second display panel which is smaller in pixel count than the first display panel; and
a driver IC which outputs common drive signals to be supplied to the first display panel and the second display panel to drive the first and second display panels both, and which outputs drive signals to be supplied to drive the first display panel alone,
wherein linear electrodes, which constitute pixels, and a dummy electrode, which does not constitute pixels, are provided in the second display panel,
wherein the drive signals are supplied to the dummy electrode,
wherein the first display panel has, in a region other than a region that constitutes pixels, wires that are used to drive the first display panel and the second display panel both, and wires that are used to drive the display panel alone, and
the resistance of the wires that are used to drive the first display panel alone is larger than the resistance of the wires that are used to drive the first display panel and the display panel both.

7. A display device according to claim 6, wherein the dummy electrode is placed outside of a display screen of the second display panel.

8. A display device according to claim 6, wherein the plurality of dummy electrodes are arranged adjacent to one another.

9. A display device according to claim 8,
wherein the plurality of dummy electrodes are smaller in area than the linear electrodes which constitute a display screen, the plurality of dummy electrodes have progressively smaller areas as a distance from the display screen increases, and
wherein, conversely, resistance of the wires connecting the first display panel to the dummy electrodes is increased gradually.

10. A display device according to claim 6,
wherein only one dummy electrode is provided, which has half an area of the linear electrodes constituting a display ascrren, and
wherein the wiring resistance of the region of the first display panel that is connected to the dummy electrode is an approximately intermediate value between the wiring resistance of the region where the first display panel alone is driven and the wiring resistance in the region where the first and the second display panel are driven both.
